(19) United States
(12) Patent Application Publication
(10) Pub. No.: US 2025/0305916 A1
(43) Pub. Date: Oct. 2, 2025

(54) DEVICE AND METHOD FOR EMBEDDING TISSUE SAMPLE

(71) Applicant: Leica Biosystems Nussloch GmbH, Nussloch (DE)

(72) Inventors: Chun JIN, Shanghai (CN); Jingguang SUN, Shanghai (CN); Xufeng YU, Shanghai (CN); Jue CHEN, Shanghai (CN)

(21) Appl. No.: 18/865,996

(22) PCT Filed: May 16, 2022
(86) PCT No.: PCT/CN2022/092984

§ 371 Date: Nov. 14, 2024

(51) Int. Cl. G01N 1/36

(52) U.S. Cl. CPC G01N 1/36; G01N 2001/366; G01N 2001/368

(57) ABSTRACT

A device for embedding a tissue sample includes a tissue cassette (10) and a mold (20). The tissue cassette (10) includes a frame (120), a top cover (100) coupled to the frame (120), and a bottom cover (110) coupled to the frame (120). The mold (20) defines a recess (220). The top and bottom covers hold the tissue sample therebetween. The top and bottom covers are capable of moving from a first position to a second position with respect to the frame (120), and in the second position the bottom cover (110) extend beyond a bottom face (123) of the frame (120) and is separated from the frame (120) and the top cover (100); the tissue cassette (10) is mountable on the mold (20), and the recess (220) is configured to receive the bottom cover (110) in the second position, such that a paraffin block (90) obtained by dispensing and cooling molten paraffin in the mold (20) is detachable from the mold (20) while the bottom cover (110) is remained in the mold (20).

### CROSS-REFERENCE TO RELATED APPLICATION(S)

This application is the national phase of PCT Application No. PCT/CN2022/092984 filed on May 16, 2022, the contents of which are incorporated by reference herein in their entirety.

### FIELD

The present disclosure relates to the field of pathological tissue, and more particularly to a device and a method for embedding a tissue sample.

### BACKGROUND

To accurately diagnose various tissue diseases and conditions, medical personnel must remove one or more samples of tissue from the body of a patient. This process of harvesting tissue from the body is known as a histopathological examination. Once the tissue sample or samples are removed and sent to a pathology laboratory, the tissue will go through a series of procedures performed by a histotechnician and, ultimately, a pathologist, in order to diagnose one or more conditions associated with the tissue.

In order to properly process the tissue sample a series of steps may be performed including: 1. Grossing of the sample by cutting the sample to the proper size for analysis. 2. Processing of the sample to immobilize molecular components and/or prevent degradation, generally including fixation, dehydration, clearing and wax infiltration of the tissue sample. 3. Embedding the sample in an embedding material, such as paraffin wax. 4. Sectioning the embedded sample by using, for example, a microtome.

Tissue cassettes may be used both in the embedding of the tissue sample and sectioning of the embedded tissue sample for holding the tissue sample.

U.S. Pat. No. 11,226,272B2 relates to a histologic tissue sample support device, which includes a tissue cassette having a recess including at least one side wall and a bottom wall, the tissue cassette formed of material that can be successfully sectioned in a microtome and is resistant to degradation from solvents and chemicals used to fix, process and stain tissue; a frame including a bottom edge, the tissue cassette being movably coupled to the frame; and a lid coupled to the frame. The lid and the tissue cassette are capable of moving from a first position to a second position with respect to the frame, and in the second position the bottom wall and at least a portion of the side wall extend beyond the bottom edge of the frame for sectioning in the microtome.

The sliceable material of the tissue cassette may increase blade consumption that causes customer's complaints.

### SUMMARY

Embodiments of the present disclosure seek to solve at least one of the problems existing in the related art to at least some extent. Embodiments of present disclosure provide a device and a method for embedding a tissue sample, which do not require the tissue cassette to be made of a sliceable material.

According to a first aspect of the present disclosure, a device for embedding a tissue sample is provided. The device includes a tissue cassette and a mold. The tissue cassette includes a frame having a bottom face, a top cover coupled to the frame, and a bottom cover movably coupled to the frame. The mold includes a mold body defining a recess having at least one side wall and a bottom wall. The top cover and the bottom cover are configured to hold the tissue sample therebetween. The top cover and the bottom cover are capable of moving from a first position to a second position with respect to the frame, and in the second position the bottom cover extend beyond the bottom face of the frame and is separated from the frame and the top cover; the tissue cassette is mountable on the mold, and the recess is configured to receive the bottom cover in the second position, such that a paraffin block obtained by dispensing and cooling molten paraffin in the mold is detachable from the mold while the bottom cover is remained in the mold.

In the device according to embodiments of the present disclosure, during the embedding of the tissue sample, the tissue cassette may be mounted on the mold, and the top cover and the bottom cover may be moved from the first position to the second position. Thus, the bottom cover can be separated from the frame and the top cover and received in the recess of the mold; and after dispensing and cooling the molten paraffin in the mold, the resulting paraffin block with the frame and the top cover may be detached from the mold and the bottom cover received in the mold. In other words, the resulting paraffin block is exposed out of the frame and does not contain the bottom cover. Hence, the tissue cassette does not need to be made of a sliceable material.

In some embodiments, a bottom wall of the bottom cover defines an opening, the bottom wall of the recess forms a projection, and in the second position, the projection of the recess fits in the opening of the bottom cover. The opening in the bottom wall of the bottom cover fits with the projection on the bottom wall of the recess to prevent the bottom cover from moving with the paraffin block when detaching the paraffin block from the mold, as the fit of the opening and the projection may prevent the formation of a solidified paraffin layer to reduce the connection between the paraffin block and the bottom cover.

In some embodiments, the bottom cover defines a groove in an outer side wall of the bottom cover, the mold defines a groove in an inner side wall of the recess, and in the second position the groove in the bottom cover and the groove in the recess cooperate to define an accommodating space. Thus, when the paraffin block is formed, a paraffin strip may also form in the accommodating space between the bottom cover and the mold, and the connection between the bottom cover and the mold may be enhanced to prevent the bottom cover from moving the paraffin block when detaching the paraffin block from the mold.

In some embodiments, the mold defines a through hole extending from a bottom face of the mold body to a top face of the mold body, the mold includes a biasing means fitted in the through hole from below, to normally engage the bottom face of the frame. Thus, top faces of the pin of the biasing means are on the same level as a step face of the mold to prevent the formation of a solidified paraffin layer, which is conducive to reducing the detaching force for separating the paraffin block.

In some embodiments, the through hole is in communication with the recess laterally via a communication slot. Thus, the bottom cover received in the recess of the mold can be accessed by passing a tool through the through hole and the communication slot sequentially, to help removal of the bottom cover from the mold.

In some embodiments, the mold includes a step face recessed from the top face of the mold body and surrounding the recess, and when the tissue cassette is mounted on the mold the bottom face of the frame is supported on the step face. Thus, the tissue cassette may be accurately and stably positioned on the mold.

In some embodiments, the bottom cover is provided with a rim horizontally protruding outwards from a top edge of the bottom cover, the frame is provided with a first protrusion protruding inwards from an inner side wall of the frame and located at a first level; and in the first position, the rim of the bottom cover is supported on the first protrusion of the frame, and the top cover is supported on the bottom cover. Thus, the top cover and the bottom cover can be prevented from moving downward to be held in the first position.

In some embodiments, the frame is further provided with a second protrusion protruding inwards from the inner side wall of the frame and located at a second level higher than the first level, the top cover is provided with a first tab horizontally protruding outwards from an outer side wall of top cover; and in the first position, the first tab of the top cover is elastically engaged with the second protrusion of the frame from below. Thus, the top cover and the bottom cover can be prevented from moving upwards to be held in the first position stably, and the location and orientation of the tissue sample between the top cover and the bottom cover can be ensured.

In some embodiments, the frame is provided with a third protrusion protruding inwards from an inner side wall of the frame and are located at a third level lower than the first level, the top cover is provided with a second tab horizontally protruding outwards from an outer side wall of top cover; and in the second position, the second tab of the top cover is supported on the third protrusion of the frame. Thus, the top cover can be prevented from moving downwards to be held in the second position.

In some embodiments, the frame is provided with a fourth protrusion protruding inwards from the inner side wall of the frame and are located at a fourth level higher than the third level and lower than the first level, the top cover is provided with a third tab horizontally protruding outwards from the outer side wall of top cover; and in the second position, the third tab of the top cover is elastically engaged with the fourth protrusion of the frame from below. Thus, the top cover can be prevented from moving upwards to be held in the second position stably.

In some embodiments, the device further includes a gripper having a gripper body, and two opposite side plates coupled to the gripper body, wherein each side plate is provided with a hook claw at an end thereof, at least one of the two side plates is movable relative to the gripper body to adjust a distance between the two side plates, and the gripper is configured to grip the frame or the bottom cover from opposite sides of the frame or the bottom cover via the hook claws on the opposite two side plates. Thus, the detachment of the paraffin block from the mold or the removal of the bottom cover from the mold can be automated by using the gripper.

In some embodiments, at least one of the two side plates is coupled to the gripper body through a screw. Thus, the gripper can be easily achieved and cost-effective.

According to a second aspect of the present disclosure, a method for embedding a tissue sample is provided. The method uses a device according to any of the above-described embodiments. The method includes: loading the tissue cassette on the mold; staging down the bottom cover of the tissue cassette into the recess of the mold; dispensing molten paraffin into the mold; cooling the mold to solidify paraffin to form a paraffin block; detaching the paraffin block with the frame and the top cover from the mold whiling the bottom cover is remained in the mold; heating the mold to molten the paraffin in the mold; and removing the bottom cover from the mold.

In some embodiments, removing the bottom cover from the mold includes grasping the bottom cover by a gripper; and lifting the gripper to remove the bottom cover from the mold. Thus, the removal of the bottom cover can be automated, to reduce operator labor intensity.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is an exploded perspective view of a tissue cassette 10 according to an embodiment of the present disclosure.

FIG. 2A is a top plan view of a tissue cassette 10 in accordance with an embodiment of the present disclosure with a top cover and a bottom cover in a first position.

FIG. 2B is a cross sectional view of the tissue cassette 10 taken along line M-M in FIG. 2A.

FIG. 2C is a partially enlarged view of a portion A in FIG. 2B.

FIG. 2D is a partially enlarged view of a portion B in FIG. 2B.

FIG. 3A is a top plan view of a tissue cassette 10 in accordance with an embodiment of the present disclosure with a top cover and a bottom cover in a second position.

FIG. 3B is a cross sectional view of the tissue cassette 10 taken along line N-N in FIG. 3A.

FIG. 3C is a partially enlarged view of a portion A in FIG. 3B.

FIG. 3D is a partially enlarged view of a portion B in FIG. 3B.

FIG. 4 is a perspective view of a mold 20 according to an embodiment of the present disclosure.

FIG. 5 is a perspective view of an assembly of a tissue cassette in a first position and a mold according to an embodiment of the present disclosure.

FIG. 6 is a cutaway view of the assembly of the tissue cassette in a first position and the mold shown in FIG. 5.

FIG. 7 is a cutaway view of an assembly of the tissue cassette in a second position and the mold according to an embodiment of the present disclosure.

FIG. 8 is a cross-sectional view of an assembly of the tissue cassette in a second position and the mold according to an embodiment of the present disclosure.

FIG. 9 is a cutaway view showing a processing of filling molten paraffin in a mold according to an embodiment of the present disclosure.

FIG. 10 is a perspective view showing a process of detaching a paraffin block with a top cover and a frame from a mold with a bottom cover.

FIG. 11 is a partially enlarged view of a portion C in FIG. 11.

FIG. 12 is a perspective view showing a processing of grasping a bottom cover using a gripper according to an embodiment of the present disclosure.

FIG. 13 is a perspective view showing a process of removing a bottom cover from a mold according to an embodiment of the present disclosure.

### DETAILED DESCRIPTION OF THE DISCLOSURE

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship in which structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

According to a first aspect of the present disclosure, a device for embedding a tissue sample is provided. The device includes a tissue cassette and a mold. The tissue cassette includes a frame having a bottom face, a top cover coupled to the frame, and a bottom cover movably coupled to the frame. The mold includes a mold body defining a recess having at least one side wall and a bottom wall. The top cover and the bottom cover are configured to hold the tissue sample therebetween. The top cover and the bottom cover are capable of moving from a first position to a second position with respect to the frame, and in the second position the bottom cover extend beyond the bottom face of the frame and is separated from the frame and the top cover; the tissue cassette is mountable on the mold, and the recess is configured to receive the bottom cover in the second position.

In the device according to embodiments of the present disclosure, during the embedding of the tissue sample, the tissue cassette may be mounted on the mold, and the top cover and the bottom cover may be moved from the first position to the second position. Thus, the bottom cover can be separated from the frame and the top cover and received in the recess of the mold; and after dispensing and cooling the molten paraffin in the mold, the resulting paraffin block with the frame and the top cover may be detached from the mold while the bottom cover remains in the mold. In other words, the resulting paraffin block is exposed out of the frame and does not contain the bottom cover. Hence, the tissue cassette does not need to be made of a sliceable material.

In some embodiments, a bottom wall of the bottom cover defines an opening, the bottom wall of the recess forms a projection, and in the second position, the projection of the recess fits in the opening of the bottom cover. The opening in the bottom wall of the bottom cover fits with the projection on the bottom wall of the recess to prevent the bottom cover from moving with the paraffin block when detaching the paraffin block from the mold, as the fit of the opening and the projection may prevent the formation of a solidified paraffin layer to reduce the connection between the paraffin block and the bottom cover.

The shape and size of the opening of the bottom cover match the shape and size of the projection of the recess. The opening of the bottom cover and the projection of the recess may be elongated, cylindrical, prismatic, or other shapes.

In some other embodiments, a plurality of openings may be defined in the bottom wall of the bottom cover, and a plurality of projections may be formed on the bottom wall of the recess. The plurality of openings of the bottom cover may be in one-to-one correspondence with the plurality of projections of the recess. Thus, the connection between the paraffin block and the bottom cover may be further reduced.

In some embodiments, the bottom cover defines a groove in an outer side wall of the bottom cover, the mold defines a groove in an inner side wall of the recess, and in the second position the groove in the bottom cover and the groove in the recess cooperate to define an accommodating space. Thus, when the paraffin block is formed, a paraffin strip may also form in the accommodating space between the bottom cover and the mold, and the connection between the bottom cover and the mold may be enhanced to prevent the bottom cover from moving the paraffin block when detaching the paraffin block from the mold.

The shape and size of the groove in the bottom cover match the shape and size of the groove in the recess. The groove of the bottom cover and the groove of the recess may be elongated, cylindrical, prismatic, or other shapes.

In some other embodiments, a plurality of grooves may be defined in the outer side wall of the bottom cover, and a plurality of grooves may be defined in the inner side wall of the recess. The plurality of grooves of the bottom cover may be in one-to-one correspondence with the plurality of grooves of the recess. Thus, the connection between the bottom cover and the mold may be further enhanced.

In some embodiments, the mold defines a through hole extending from a bottom face of the mold body to a top face of the mold body, the mold includes a biasing means fitted in the through hole from below, to normally engage the bottom face of the frame. Thus, top faces of the pin of the biasing means are on the same level as the step face of the mold to prevent the formation of a solidified paraffin layer, which is conducive to reducing the detaching force for separating the paraffin block.

In some other embodiments, a plurality of through holes may be defined in the mold body, and a plurality of biasing means may be arranged in the plurality of through holes, respectively. Thus, a detaching force required when the paraffin block is detached from the mold may be further reduced.

In some embodiments, the through hole is in communication with the recess laterally via a communication slot. Thus, the bottom cover received in the recess of the mold can be accessed by passing a tool through the through hole and the communication slot sequentially, to help removal of the bottom cover from the mold.

In some embodiments, the mold includes a step face recessed from the top face of the mold body and surrounding the recess, and when the tissue cassette is mounted on the mold the bottom face of the frame is supported on the step face. Thus, the tissue cassette may be accurately and stably positioned on the mold.

It could be understood that the through hole may extend vertically through the bottom face of the mold body and the step face.

In some embodiments, the bottom cover is provided with a rim horizontally protruding outwards from a top edge of the bottom cover, the frame is provided with a first protrusion protruding inwards from an inner side wall of the frame and located at a first level; and in the first position, the rim of the bottom cover is supported on the first protrusion of the frame, and the top cover is supported on the bottom cover. Thus, the top cover and the bottom cover can be prevented from moving downward to be held in the first position.

In some embodiments, the frame is further provided with a second protrusion protruding inwards from the inner side wall of the frame and located at a second level higher than the first level, the top cover is provided with a first tab horizontally protruding outwards from an outer side wall of top cover; and in the first position, the first tab of the top cover is elastically engaged with the second protrusion of the frame from below. Thus, the top cover and the bottom cover can be prevented from moving upwards to be held in the first position stably, and the location and orientation of the tissue sample between the top cover and the bottom cover can be ensured.

In some embodiments, the frame is provided with a third protrusion protruding inwards from an inner side wall of the frame and are located at a third level lower than the first level, the top cover is provided with a second tab horizontally protruding outwards from an outer side wall of top cover; and in the second position, the second tab of the top cover is supported on the third protrusion of the frame. Thus, the top cover can be prevented from moving downwards to be held in the second position.

In some embodiments, the frame is provided with a fourth protrusion protruding inwards from the inner side wall of the frame and are located at a fourth level higher than the third level and lower than the first level, the top cover is provided with a third tab horizontally protruding outwards from the outer side wall of top cover; and in the second position, the third tab of the top cover is elastically engaged with the fourth protrusion of the frame from below. Thus, the top cover can be prevented from moving upwards to be held in the second position stably.

In some embodiments, the device further includes a gripper having a gripper body, and two opposite side plates coupled to the gripper body, wherein each side plate is provided with a hook claw at an end thereof, at least one of the two side plates is movable relative to the gripper body to adjust a distance between the two side plates, and the gripper is configured to grip the frame or the bottom cover from opposite sides of the frame or the bottom cover via the hook claws on the opposite two side plates. Thus, the detachment of the paraffin block from the mold or the removal of the bottom cover from the mold can be automated by using the gripper.

In some embodiments, at least one of the two side plates is coupled to the gripper body through a screw. Thus, the gripper can be easily achieved and cost-effective.

According to a second aspect of the present disclosure, a method for embedding a tissue sample is provided. The method uses a device according to any of the above-described embodiments. The method includes: loading the tissue cassette on the mold; staging down the bottom cover of the tissue cassette into the recess of the mold; dispensing molten paraffin into the mold; cooling the mold to solidify paraffin to form a paraffin block; detaching the paraffin block with the frame and the top cover from the mold; heating the mold to molten the paraffin in the mold; and removing the bottom cover from the mold.

In some embodiments, removing the bottom cover from the mold includes grasping the bottom cover by a gripper; and lifting the gripper to remove the bottom cover from the mold. Thus, the removal of the bottom cover can be automated, to reduce operator labor intensity.

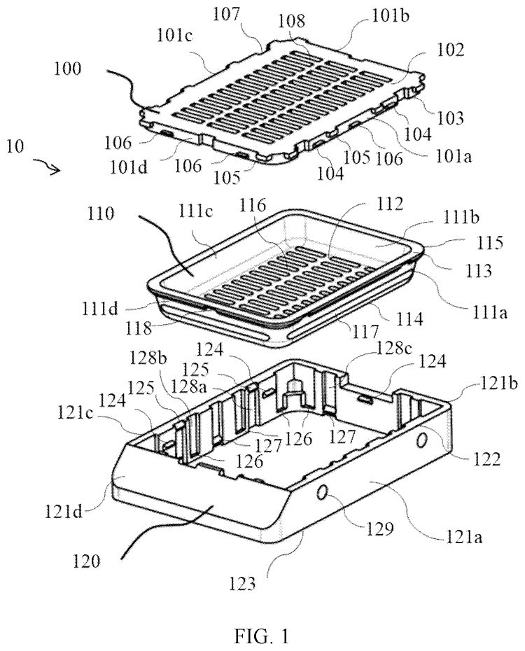

A device for embedding a tissue sample according to an embodiment of the present disclosure will be described below with reference to FIGS. 1 to 13. The device may be a tissue embedding machine, in particular an auto embedder.

FIG. 1 is an exploded perspective view of a tissue cassette 10 according to an embodiment of the present disclosure. As illustrated in FIG. 1, the tissue cassette 10 includes a top cover 100, a bottom cover 110, and a frame 120. The top cover 100 and the bottom cover 110 may be mounted on the frame 120 to receive a tissue sample between the top cover 100 and the bottom cover 110. The top cover 100 and the bottom cover 110 are movable relative to the frame 120 from a first position to a second position.

The top cover 100 is a substantially rectangular plate. The top cover 100 includes a first side 101a, a second side 101b, a third side 101c, and a fourth side 101d that are coupled end to end. The first and third sides 101a and 101c are opposite to each other and configured as long sides. The second and fourth sides 101b and 101d are opposite to each other and configured as short sides. The top cover 100 also has a top face 102 and a bottom face 103 opposite to each other.

The top cover 100 is provided with four first tabs 104 horizontally protruding outwards from the first and third sides 101a, 101c, and the four first tabs 104 are evenly distributed on the first and third sides 101a, 101c. The four first tabs 104 are located close to the bottom face 103.

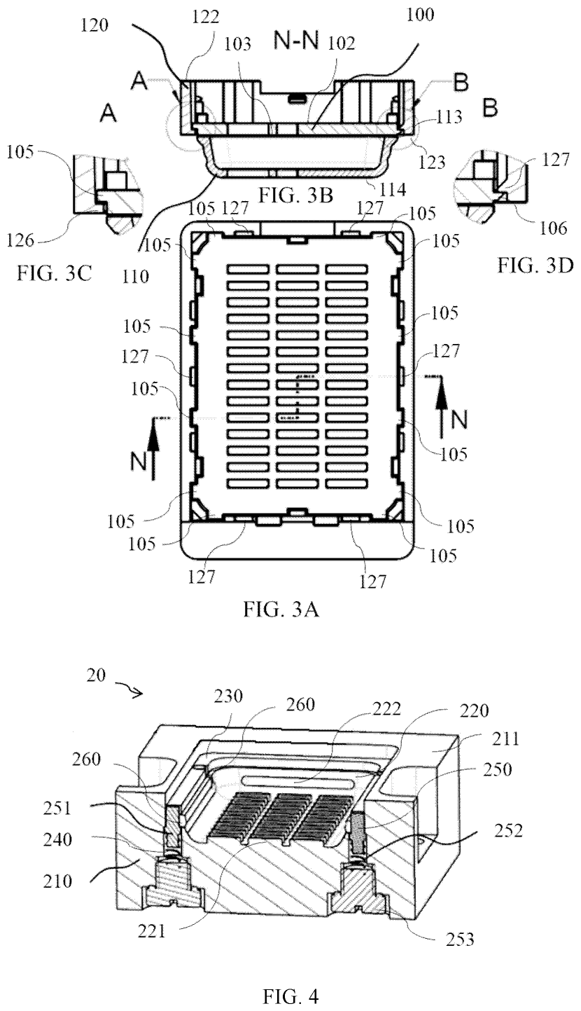

The top cover 100 is also provided with twelve second tabs 105 horizontally protruding outwards from the first through fourth sides 101a, 101b, 101c, 101d (best illustrated in FIG. 3A). Eight of the second tabs 105 are evenly distributed on the first and third sides 101a, 101c, and the other four of the second tabs 105 are evenly distributed on the second and fourth sides 101b, 101d. The twelve second tabs 105 are located adjacent to the top face 102. In other words, the level of the twelve second tabs 105 is higher than the level of the four first tabs 104.

The top cover 100 is further provided with six third tabs 106 horizontally protruding outwards from the first through fourth sides 101a, 101b, 101c, 101d. Two of the third tabs 106 are evenly distributed on the first and third sides 101a, 101c, and the other four of third tabs 106 are evenly distributed on the second and fourth sides 101b, 101d. The level of the six third tabs 106 is substantially the same as the level of the four first tabs 104.

The top cover 100 defines six avoidance notches 107 horizontally recessed from the first through fourth sides 101a, 101b, 101c, 101d and vertically extending through the top face 102 and the bottom face 103. Four of the avoidance notches 107 are evenly distributed on the first and third sides 101a, 101c, and the other two of the avoidance notches 107 are evenly distributed on the second and fourth sides 101b, 101d.

The top cover 100 further defines a plurality of elongated openings 108 vertically extending through the top face 102 and the bottom face 103. During embedding of the tissue sample, molten paraffin can be dispensed through the elongated openings 108.

The bottom cover 110 has a substantially rectangular box shape with an open top. The bottom cover 110 includes a first side wall 111a, a second side wall 111b, a third side wall 111c, and a fourth side wall 111d that are coupled end to end; and a bottom wall 112 that is coupled to lower ends of the first through fourth side walls 111a, 111b, 111c, 111d. The first and third side walls 111a and 111c are opposite to each other and configured as long side walls. The second and fourth side walls 111b and 111d are opposite to each other and configured as short side walls. The bottom cover 110 also has a top face 113 and a bottom face 114 opposite to each other. Herein, the top face 113 is also a top face of the first through fourth side walls 111a, 111b, 111c, 111d, and the bottom face 114 is also a bottom face of the bottom wall 112.

The bottom cover 110 is provided with a rim 115 horizontally protruding outwards from and surrounding the first through fourth side walls 111a, 111b, 111c, 111d adjacent to the top face 113 of the bottom cover 110.

The bottom cover 110 defines a plurality of elongated openings 116 in the bottom wall 112 vertically extending through a top face and a bottom face of the bottom wall 112.

The bottom cover 110 also defines four elongated grooves 117 horizontally extending along outer sides of the first through fourth side walls 111a, 111b, 111c, 111d, respectively.

The bottom cover 110 further defines six depressions 118 in a bottom face of the rim 115. Four of the depressions 118 are evenly distributed in the portions of the rim 115 on the first and third side walls 111a, 111c, and the other two of the depressions 118 are evenly distributed in the portions of the rim 115 on the second and fourth side walls 111b, 111d.

The frame 120 has a substantially rectangular shape with an open top and bottom. The frame 120 has a first wall 121a, a second wall 121b, a third wall 121c and a fourth wall 121d, and the first through fourth walls, 121a, 121b, 121c, 121d are coupled end to end. The first wall 121a and the third wall 121c are long walls and opposite each other, and the second wall 121b and the fourth wall 121d are short walls and opposite each other. The frame 120 has a top face 122 and a bottom face 123 opposite to each other.

The frame 120 is provided with six first protrusions 124 horizontally protruding inwards from inner sides of the first through fourth walls, 121a, 121b, 121c, 121d. Four of the first protrusions 124 are distributed on inner sides of the opposite first and third walls 121a, 121c of the frame 120, and the other two of the first protrusions 124 are distributed on inner sides of the opposite second and fourth walls 121b, 121d of the frame 120.

The first protrusions 124 correspond to the avoidance notches 107 of the top cover 100 in position, and when the top cover 100 is moved vertically in the frame 120, the top cover 120 can pass through the first protrusions 124 by means of the avoidance notches 107 without hindrance.

The first protrusions 124 also correspond to the depressions 118 of the bottom cover 110 in position, and when the bottom cover 110 is mounted in the frame 120, the first protrusions 124 fit in the depressions 118, respectively, to stably support the bottom cover 110 in the frame 120.

The frame 120 is further provided with four second protrusions 125 protruding inwards from inner sides of the first and third walls 121a, 121c and located higher than the first protrusions 124. The four second protrusions 125 are evenly distributed on the inner sides of the opposite first and third walls 121a, 121c of the frame 120.

The second protrusions 125 correspond to the first tabs 104 of the top cover 100 in position. The first tabs 104 of the top cover 100 may be elastically engaged with the four second protrusions 125 of the frame 120 from below, to limit upward movement of the top cover 100.

The frame 120 is provided with twelve third protrusions 126 that protrude inwards from inner sides of the first through fourth walls 121a, 121b, 121c, 121d. The third protrusions 126 are lower than the first protrusions 124 and are adjacent to the bottom face 123 of the frame 120. Eight of the third protrusions 126 are evenly distributed on the inner sides of the first and third walls 121a, 121c, and the other four of the third protrusions 126 are evenly distributed on the inner sides of the second and fourth walls 121b, 121d.

The third protrusions 126 correspond to the second tabs 105 of the top cover 100 in position. The second tabs 105 of the top cover 100 can be supported on the third protrusions 126 to limit downward movement of the top cover 100 within the frame 120.

The frame 120 is provided with six fourth protrusions 127 that protrude inwards from inner sides of the first through fourth walls 121a, 121b, 121c, 121d of the frame 120. The fourth protrusions 127 are located lower than the first protrusions 124 and slightly higher than the third protrusions 126. Two of the fourth protrusions 127 are evenly distributed on the opposite first and third walls 121a, 121c, and the other four of the fourth protrusions 127 are evenly distributed on the opposite second and fourth walls 121b, 121d of the frame 120.

The fourth protrusions 127 correspond to the third tabs 106 of the top cover 100 in position. The six third tabs 106 of the top cover 100 may be elastically engaged with the six fourth protrusions 127 of the frame 120 from below, respectively, to limit upward movement of the top cover 100.

The frame 120 further defines guide grooves in the inner sides of the first through fourth walls 121a, 121b, 121c, 121d extending vertically for guiding movement of the top cover 100 within the frame 120.

The frame 120 may define four first guide grooves 128a vertically extending in the inner sides of the first and third walls 121a, 121c. The first guide grooves 128a correspond to the first tabs 104 of the top cover 100 in position and configured to receive the first tabs 104 of the top cover 100. The first tabs 104 may be moved along the first guide grooves 128a. The second protrusions 125 of the frame 120 may be formed in the first guide grooves 128a, respectively, to avoid blocking movement of the bottom cover 110 within the frame 120.

The frame 120 may further define twelve second guide grooves 128b vertically extending in the inner sides of the first through fourth walls 121a, 121b, 121c, 121d. The second guide grooves 128b correspond to the second tabs 105 of the top cover 100 in position and configured to receive the second tabs 105 of the top cover 100, respectively. The second tabs 105 of the top cover 100 may move along the second guide grooves 128b. The third protrusions 126 of the frame 120 may be formed in the second guide grooves 128b, respectively, to avoid blocking movement of the bottom cover 110 within the frame 120.

The frame 120 may further define six third guide grooves 128c vertically extending in the inner sides of the first through fourth walls 121a, 121b, 121c, 121d. The third guide grooves 128c correspond to the third tabs 106 of the top cover 100 in position and configured to receive the third tabs 106 of the top cover 100, respectively. The third tabs 106 of the top cover 100 may move along the third guide grooves 128c. The fourth protrusions 127 of the frame 120 may be formed in the third guide grooves 128c, respectively, to avoid blocking movement of the bottom cover 110 within the frame 120.

The frame 120 further defines four conical grooves 129 in outer sides of the first and third walls 121a, 121c. The four conical grooves 129 are evenly distributed on the first and third walls 121a, 121c. The conical grooves 129 may facilitate lifting and transferring of the frame 102 or the tissue cassette 10 manually or automatically by using a tool or mechanism that may engage in the conical grooves 129.

As mentioned above, the tissue cassette 10 may have two positions. In a first position, the top cover 100 and the bottom cover 110 are mounted in the frame 120, and the bottom face 114 of the bottom cover 110 is substantially in the same level as the bottom face 123 of the frame 120. That is, the top cover 100 and the bottom cover 110 are located at an upper position relative to the frame 120. In a second position, the top cover 100 is still mounted in the frame 120, the bottom face 103 of the top cover 100 is substantially in the same level as the bottom face 123 of the frame 120, and the bottom cover 110 is separated from the frame 120 and the top cover 100. That is, the top cover 100 and the bottom cover 110 are located at a lower position relative to the frame 120.

The tissue cassette 10 can be converted from the first position to the second position by staging down the top cover 100 and the bottom cover 110 via a tool or mechanism. After a tissue sample is put into the tissue cassette 10, the tissue cassette 10 needs to be kept in the first position before embedding of the tissue sample.

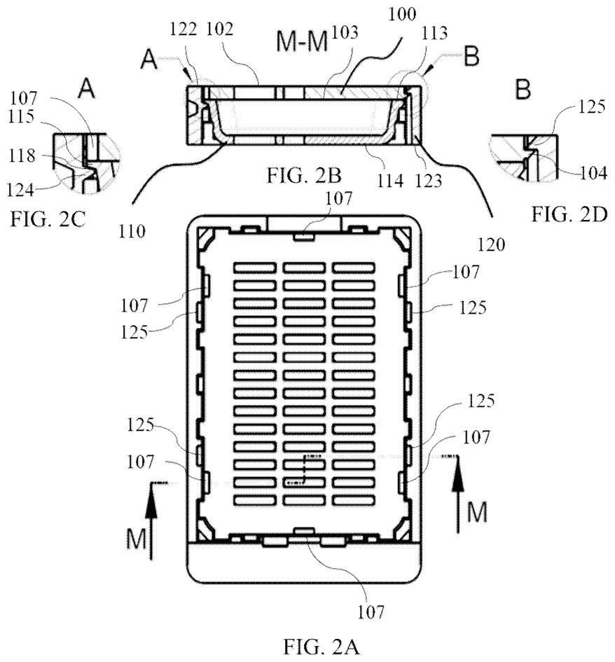

FIG. 2A is a top plan view of a tissue cassette 10 in accordance with an embodiment of the present disclosure with a top cover and a bottom cover in a first position. FIG. 2B is a cross sectional view of the tissue cassette 10 taken along line M-M in FIG. 2A. FIG. 2C is a partially enlarged view of a portion A in FIG. 2B. FIG. 2D is a partially enlarged view of a portion B in FIG. 2B.

As illustrated in FIG. 2B, in the first position of the tissue cassette 10, the top cover 100 and the bottom cover 110 are mounted in the frame 120 and located at the upper position relative to the frame 120. The top face 102 of the top cover 100 is substantially in the same level of the top face 122 of the frame 120, and the bottom face 114 of the bottom cover 110 is substantially in the same level of the bottom face 123 of the frame 120.

The rim 115 of the bottom cover 110 is supported on the first protrusions 124 of the frame 120. For example, the depressions 118 of the rim 115 are fitted with the first protrusions 124 of the frame 120, respectively, to stably support the bottom cover 110 in the frame 120, as illustrated in FIG. 2C in detail. The top cover 100 is placed on the bottom cover 110. That is, the bottom face 103 of the top cover 100 is in contact with the top face 113 of the bottom cover 110.

The first tabs 104 of the top cover 100 are elastically engaged with the second protrusions 125 of the frame 120 from below, respectively, as illustrated in FIG. 2D in detail. Hence, the top cover 100 and the bottom cover 110 are stably held in the first position by the first and the second protrusions 125 of the frame 120.

FIG. 3A is a top plan view of a tissue cassette 10 in accordance with an embodiment of the present disclosure with a top cover and a bottom cover in a second position. FIG. 3B is a cross sectional view of the tissue cassette 10 taken along line N-N in FIG. 3A. FIG. 3C is a partially enlarged view of a portion A in FIG. 3B. FIG. 3D is a partially enlarged view of a portion B in FIG. 3B.

As illustrated in FIG. 3B, in the second position of the tissue cassette 10, the top cover 100 is mounted in the frame 120 and located at the lower position relative to the frame 120, and the bottom cover 110 is separated from the frame 120 and the top cover 100. The top cover 100 and the bottom cover 110 may be staged down from the upper position to the lower position relative to the frame 120. The second tabs 105 of the top cover 100 are supported on the third protrusions 126 of the frame 120, respectively. The third tabs 106 of the top cover 100 are elastically engaged with the fourth protrusions 127 of the frame 120 from below, respectively. In other words, the top cover 100 is held in the second position by means of cooperation of the third and fourth protrusions 126, 127 with the second and third tabs 105, 106. The bottom face 103 of the top cover 100 is substantially in the same level as the bottom face 123 of the frame 120. The bottom cover 110 is completely out of the frame 120, and separated from the frame 120 and the top cover 100.

FIG. 4 is a perspective view of a mold 20 according to an embodiment of the present disclosure. As illustrated in FIG. 4, the device further includes a mold 20. The mold 20 includes a mold body 210, a recess 220 recessed from a top face 211 of the mold body 210, and a step face 230 formed surrounding an opening of the recess 220. The recess 220 is configured to receive the bottom cover 110. The step face 230 is configured to fit with the bottom face 123 of the frame 120.

A plurality of elongated projections 221 are formed on a bottom wall of the recess 220, and four elongated grooves 222 are defined in four side walls of the recess 220, respectively. The four elongated grooves 222 extend horizontally. The plurality of elongated projections 221 correspond to the plurality of elongated openings 116 of the bottom cover 110 in position and are configured to fit with the elongated openings 116 of the bottom cover 110. The elongated grooves 222 of the mold 20 correspond to the elongated grooves 117 of the bottom cover 110 in position and are configured to cooperate with the elongated grooves 117 of the bottom cover 110 to define four paraffin accommodating spaces 80, as illustrated in FIG. 8.

The mold 20 also includes four through holes 240 extending from a bottom face 212 of mold body 210 to the step face 230. The mold 20 also includes four biasing means 250. Each biasing means 250 includes a pin 251, a spring 252 and a plug 253 that are sequentially fitted in a corresponding through hole 250 from below, respectively. The plug 253 is screwed into the through hole 240, and the spring 252 is provided between the pin 251 and the plug 253 to urge the pin 251 towards the step face 230. Thus, a top face of the pin 251 is substantially in the same level as the step face 230.

The four through holes 240 are also in communication with the recess 220 laterally via communication slots 260.

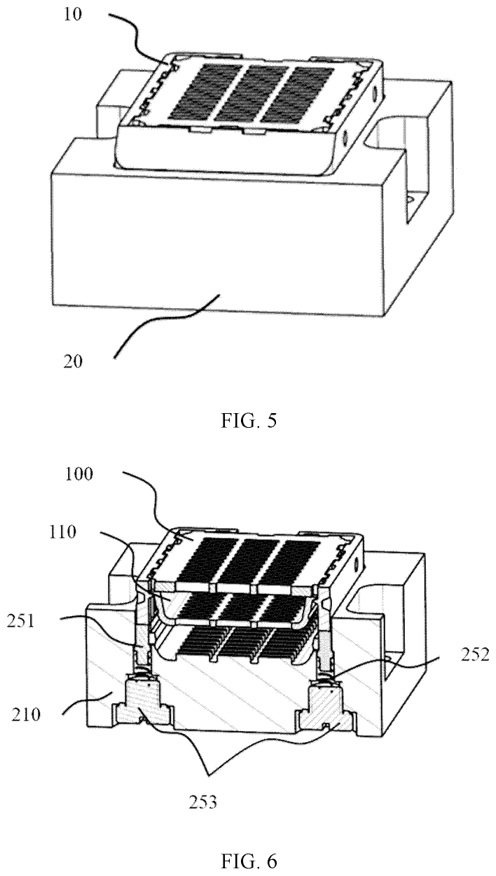

A method for embedding a tissue sample according to an embodiment of the present disclosure will be described below with reference to FIGS. 5 to 13.

FIG. 5 is a perspective view of an assembly of a tissue cassette in a first position and a mold according to an embodiment of the present disclosure. FIG. 6 is a cutaway view of the assembly of the tissue cassette in a first position and the mold shown in FIG. 5. As illustrated in FIGS. 5 and 6, in the embedding process, the tissue cassette 10 is mounted in the recess 220 of the mold 20, and the bottom face 123 of the frame 120 fits with the step face 230. The top face of the pin 251 also abuts against the bottom face 123 of the frame 120.

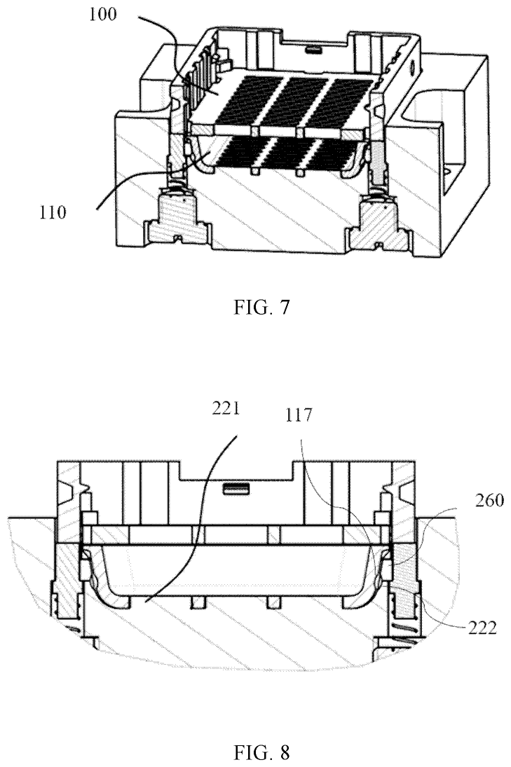

FIG. 7 is a cutaway view of an assembly of the tissue cassette in a second position and the mold according to an embodiment of the present disclosure. FIG. 8 is a cross-sectional view of an assembly of the tissue cassette in a second position and the mold according to an embodiment of the present disclosure. As illustrated in FIGS. 7 and 8, the top cover 100 and the bottom cover 110 are staged down via a tool or mechanism. The top cover 100 is in the lower position relative to the frame 120. The bottom cover 110 is completely out of the frame 120 and separated from the frame 120 and the top cover 100, and the bottom cover 110 is just fitted in the recess 220 of the mold 20. The elongated openings 108 in the bottom wall 112 of the bottom cover 110 are fitted with the elongated projections 221 formed on the bottom wall of the recess 220. The elongated grooves 117 in outer sides of the side walls 111a, 111b, 111c, 111d of the bottom cover 110 and the elongated grooves 222 in the inner side walls of the recess 220 cooperate to define the four paraffin accommodating spaces 80. The bottom face 103 of the top cover 100 may abut against the top face 113 of the bottom cover 110 received in the recess 220.

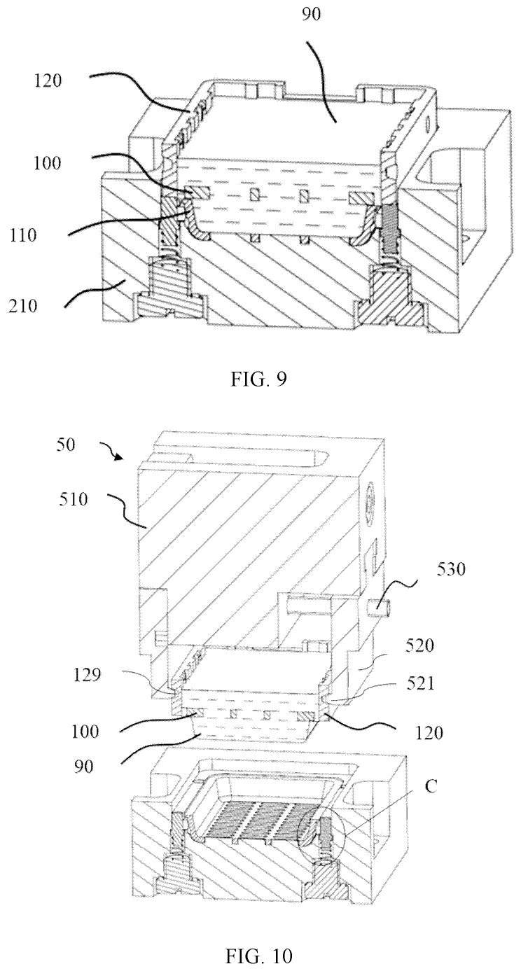

FIG. 9 is a cutaway view showing a processing of filling molten paraffin in a mold according to an embodiment of the present disclosure. As illustrated in FIG. 9, molten paraffin is dispensed into the mold 20 through the tissue cassette 10 from above, e.g., through openings 108 in the top cover 100, until a level of the molten paraffin reaches a certain position of the frame 120, e.g., a position higher than the top face 102 of the top cover 100. The mold 20 is then cooled to solidify the paraffin to obtain a solidified paraffin block 90.

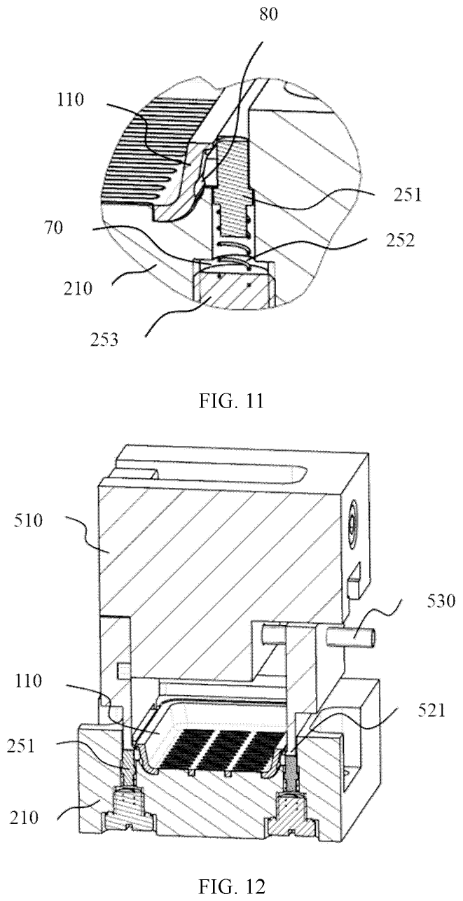

FIG. 10 is a perspective view showing a process of detaching a paraffin block with a top cover and a frame from a mold with a bottom cover. FIG. 11 is a partially enlarged view of a portion C in FIG. 11.

As illustrated in FIG. 11, after the paraffin solidifies completely, four solidified paraffin strips are formed in the four paraffin accommodating spaces 80 to enhance the connection between the bottom cover 110 and the mold body 210. The pins 251 and the springs 252 are also fixed in the through holes 240 due to the solidified paraffin in gaps 70 between the pins 251 and the plugs 253. The top faces of the pins 251 are on the same level as the step face 230 of the mold 20 to prevent the formation of a solidified paraffin layer, which is conducive to reducing the detaching force for separating the paraffin block 90.

As illustrated in FIG. 10, the paraffin block 90 with the frame 120 and the top cover 100 is detached from the mold 20 by a gripper 50. The gripper 50 includes a gripper body 510, and two side plates 520 oppositely coupled to the gripper body 510. The right side plate 520 is movably coupled to the gripper body 510 by a screw 530 such that a distance between the two side plates may be adjusted. Each of the two side plates 520 is provided with two hook claws 521. The four hook claws 521 may be fitted in truncated conical grooves 129 in the frame 120. Then the gripper 50 may move up to lift the frame 120 with the top cover 100 and the solidified paraffin block 90, achieving separation of the paraffin block 90 from the mold 20, with the bottom cover 110 retained in the mold 20.

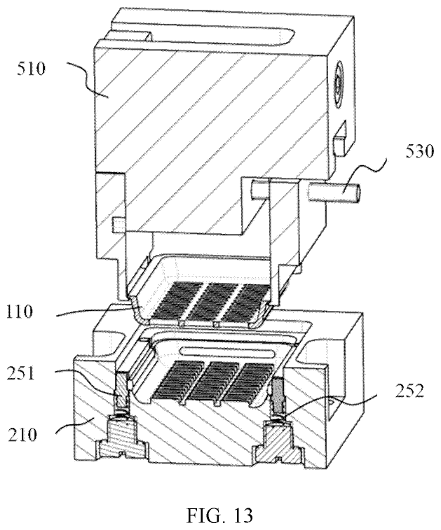

FIG. 12 is a perspective view showing a processing of grasping a bottom cover using a gripper according to an embodiment of the present disclosure. As illustrated in FIG. 12, the mold 20 is heated, and the paraffin in the mold 20 is melted gradually. The four hook claws 521 of the gripper 50 are adjusted to align with the four pins 251 in the through holes 240, respectively. The gripper 50 moves down, and the four hook claws 521 press the pins 251 into the through holes 240. The distance between the two side plates 520 can be adjusted by means of the screw 530, and then the hook claws 521 may pass through the communication slots 260 and engage the bottom cover 110 laterally. In this case, the bottom cover 110 is grasped in the mold 20 by the gripper 50.

FIG. 13 is a perspective view showing a process of removing a bottom cover from a mold according to an embodiment of the present disclosure. As illustrated in FIG. 13, the gripper 50 moves up with the bottom cover 110, and thus the bottom cover 110 is detached from the mold 20. As the gripper 50 with the bottom cover 110 is removed from the mold 20, four pins 251 will return to the initial position by the springs 252.

The resulting paraffin block 90 is completely protruded from the frame 120 and the top cover 100, and does not contain the bottom cover 110, and in the subsequent sectioning process by a microtome, no part of the frame 120 and the top cover 100 will be sliced. Thus, the device and the method for embedding a tissue sample according to embodiments of the present disclosure do not require the tissue cassette 10 to be made of a sliceable material.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

### REFERENCE LIST

10 tissue cassette
100 top cover
101a first side
101b second side
101c third side
101d fourth side
102 top face
103 bottom face
104 first tab
105 second tab
106 third tab
107 avoidance notch
108 elongated opening
110 bottom cover
111a first side wall
111b second side wall
111c third side wall
111d fourth side wall
112 bottom wall
113 top face
114 bottom face
115 rim
116 elongated opening
117 elongated groove
118 depression
120 frame
121a first wall
121b second wall
121c third wall
121d fourth wall
122 top face
123 bottom face
124 first protrusion
125 second protrusion
126 third protrusion
127 fourth protrusion
128a first guide groove
128b second guide groove
128c third guide groove
129 conical groove
20 mold
210 mold body
211 top face
212 bottom face
220 recess
221 elongated projection
222 elongated groove
230 step face
240 through hole
250 biasing means
251 pin
252 spring
253 plug
260 communication slot
50 gripper
510 gripper body
520 side plate
521 hook claw
530 screw
70 gap
80 paraffin accommodating space
90 paraffin block

1. A device for embedding a tissue sample, comprising:
a tissue cassette, comprising:
a frame having a bottom face,
a top cover coupled to the frame, and
a bottom cover movably coupled to the frame; and
a mold, comprising:
a mold body defining a recess having at least one side wall and a bottom wall,
wherein the top cover and the bottom cover are configured to hold the tissue sample therebetween; the top cover and the bottom cover are capable of moving from a first position to a second position with respect to the frame, and in the second position the bottom cover extend beyond the bottom face of the frame and is separated from the frame and the top cover; the tissue cassette is mountable on the mold, and the recess is configured to receive the bottom cover in the second position, such that a paraffin block obtained by dispensing and cooling molten paraffin in the mold is detachable from the mold while the bottom cover is remained in the mold.

2. The device according to claim 1, wherein a bottom wall of the bottom cover defines an opening, the bottom wall of the recess forms a projection, and in the second position, the projection of the recess fits in the opening of the bottom cover.

3. The device according to claim 1, wherein the bottom cover defines a groove in an outer side wall of the bottom cover, the mold defines a groove in an inner side wall of the recess, and in the second position the groove in the bottom cover and the groove in the recess cooperate to define an accommodating space.

4. The device according to claim 1, wherein the mold defines a through hole extending from a bottom face of the mold body to a top face of the mold body, and the mold comprises a biasing means fitted in the through hole from below, to normally engage the bottom face of the frame.

5. The device according to claim 4, wherein the through hole is in communication with the recess laterally via a communication slot.

6. The device according to claim 4, wherein the mold comprises a step face recessed from the top face of the mold body and surrounding the recess, such that when the tissue cassette is mounted on the mold the bottom face of the frame is supported on the step face.

7. The device according to claim 1, wherein in the second position, a bottom face of the top cover is flush with the bottom face of the frame; and the bottom face of the top cover abuts against a top face of the bottom cover received in the recess of the mold.

8. The device according to claim 1, wherein the bottom cover is provided with a rim horizontally protruding outwards from a top edge of the bottom cover, the frame is provided with a first protrusion protruding inwards from an inner side wall of the frame and located at a first level; and
in the first position, the rim of the bottom cover is supported on the first protrusion of the frame, and the top cover is supported on the bottom cover.

9. The device according to claim 8, wherein the frame is further provided with a second protrusion protruding inwards from the inner side wall of the frame and located at a second level higher than the first level, the top cover is provided with a first tab horizontally protruding outwards from an outer side wall of the top cover; and
in the first position, the first tab of the top cover is elastically engaged with the second protrusion of the frame from below.

10. The device according to claim 8, wherein the frame is provided with a third protrusion protruding inwards from the inner side wall of the frame and are located at a third level lower than the first level, the top cover is provided with a second tab horizontally protruding outwards from an outer side wall of the top cover; and
in the second position, the second tab of the top cover is supported on the third protrusion of the frame.

11. The device according to claim 10, wherein the frame is provided with a fourth protrusion protruding inwards from the inner side wall of the frame and are located at a fourth level higher than the third level and lower than the first level, the top cover is provided with a third tab horizontally protruding outwards from the outer side wall of the top cover; and
in the second position, the third tab of the top cover is elastically engaged with the fourth protrusion of the frame from below.

12. The device according to claim 1, further comprising:
a gripper having a gripper body, and two opposite side plates coupled to the gripper body, wherein each side plate is provided with a hook claw at an end thereof, at least one of the two side plates is movable relative to the gripper body to adjust a distance between the two side plates, and the gripper is configured to grip the frame or the bottom cover from opposite sides of the frame or the bottom cover via the hook claws on the opposite two side plates.

13. The device according to claim 12, wherein at least one of the two side plates is coupled to the gripper body through a screw.

14. A method for embedding a tissue sample, using a device according to claim 1, comprising:
loading the tissue cassette on the mold;
staging down the bottom cover of the tissue cassette into the recess of the mold;
dispensing molten paraffin into the mold;
cooling the mold to solidify paraffin to form a paraffin block;
detaching the paraffin block with the frame and the top cover from the mold whiling the bottom cover is remained in the mold;
heating the mold to molten the paraffin in the mold; and
removing the bottom cover from the mold.

15. The method according to claim 14, wherein removing the bottom cover from the mold comprises:
grasping the bottom cover by a gripper; and
lifting the gripper to remove the bottom cover from the mold.
